(19) United States
(12) Patent Application Publication
(10) Pub. No.: US 2014/0083079 A1
(43) Pub. Date: Mar. 27, 2014

(54) GEARED TURBOFAN PRIMARY AND SECONDARY NOZZLE INTEGRATION GEOMETRY

(71) Applicant: United Technologies Corporation, (US)

(72) Inventors: Daniel Bernard Kupratis, Wallingford, CT (US); Gregory A. Kohlenberg, Kensington, CT (US)

(73) Assignee: UNITED TECHNOLOGIES CORPORATION, Hartford, CT (US)

(21) Appl. No.: 13/687,260

(22) Filed: Nov. 28, 2012

Related U.S. Application Data
(60) Provisional application No. 61/705,699, filed on Sep. 26, 2012.

(51) Int. Cl. F02K 3/075

(52) U.S. Cl. CPC F02K 3/075
USPC 60/226.1; 60/262; 29/888.025

(57) ABSTRACT

A disclosed example geared turbofan engine includes a fan section including a plurality of fan blades rotatable about an axis and a core engine section defined about an engine axis. The core engine section includes a primary nozzle including a primary outer diameter at a primary nozzle trailing edge and a primary maximum inner diameter forward of the primary trailing edge. A bypass passage is defined between an inner nacelle surrounding the core engine section and an outer nacelle and includes a secondary nozzle. The secondary nozzle includes an outer diameter at a secondary nozzle trailing edge and a secondary maximum inner diameter forward of the secondary trailing edge. A ratio between the maximum inner diameter of the primary nozzle and an outer diameter at the trailing edge of the primary nozzle and a ratio between the maximum inner diameter of the secondary trailing edge and the outer diameter at the trailing edge of the secondary nozzle are both less than about 0.700.

### CROSS REFERENCE TO RELATED APPLICATION

This application claims priority to U.S. Provisional Application No. 61/705,699 filed on Sep. 26, 2012.

### BACKGROUND

A gas turbine engine typically includes a fan section and a core portion having a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

The high pressure turbine drives the high pressure compressor through an outer shaft to form a high spool, and the low pressure turbine drives the low pressure compressor through an inner shaft to form a low spool. The fan section may also be driven by the inner shaft. A direct drive gas turbine engine includes a fan section driven by the low spool such that the low pressure compressor, low pressure turbine and fan section rotate at a common speed in a common direction.

A speed reduction device such as an epicyclical gear assembly may be utilized to drive the fan section such that the fan section may rotate at a speed different than the turbine section so as to increase the overall propulsive efficiency of the engine. In such engine architectures, a shaft driven by one of the turbine sections provides an input to the epicyclical gear assembly that drives the fan section at a reduced speed such that both the turbine section and the fan section can rotate at closer to optimal speeds.

The core portion of the gas turbine engine includes a primary nozzle and a bypass passage for bypass flow defines a secondary nozzle. The configuration of the primary and secondary nozzles is determined to optimize propulsive efficiency.

Although geared architectures have improved propulsive efficiency, turbine engine manufacturers continue to seek further improvements to engine performance including improvements to thermal, transfer and propulsive efficiencies.

### SUMMARY

A gas turbine engine according to an exemplary embodiment of this disclosure, among other possible things includes a core engine section defined about an engine axis, a bypass passage defined about the core engine section, and a primary nozzle defined as a part of the core engine including a primary outer diameter at a primary nozzle trailing edge and a primary maximum inner diameter forward of the primary trailing edge. A ratio between the inner diameter of the primary nozzle to an outer diameter at the trailing edge of the primary nozzle is less than about 0.700.

In a further embodiment of the foregoing gas turbine engine, the bypass passage includes a secondary nozzle including a secondary outer diameter at a secondary nozzle trailing edge and a secondary maximum inner diameter forward of the secondary trailing edge. A ratio between the inner diameter of the secondary nozzle to the outer diameter at the trailing edge of the secondary nozzle is less than about 0.700.

In a further embodiment of any of the foregoing gas turbine engines, the ratio between the inner diameter of the primary nozzle to the outer diameter at the trailing edge of the primary nozzle is within a range between about 0.500 and about 0.700.

In a further embodiment of any of the foregoing gas turbine engines, the ratio between the inner diameter of the secondary nozzle to the outer diameter at the trailing edge of the secondary nozzle is within a range between about 0.500 and about 0.700.

In a further embodiment of any of the foregoing gas turbine engines, includes a fan section including a plurality of fan blades rotatable about an axis. The core engine section includes a compressor section, a combustor in fluid communication with the compressor section, a turbine section in fluid communication with the combustor, and a geared architecture driven by the turbine section for rotating the fan about the axis.

In a further embodiment of any of the foregoing gas turbine engines, the turbine section includes a fan drive turbine driving the fan section through the geared architecture.

In a further embodiment of any of the foregoing gas turbine engines, the trailing edge of the secondary nozzle includes a scalloped edge.

In a further embodiment of any of the foregoing gas turbine engines, the primary nozzle maximum inner diameter defines a portion of a gas path aft of a last turbine stage of the core engine section.

A geared turbofan engine according to an exemplary embodiment of this disclosure, among other possible things includes a fan section including a plurality of fan blades rotatable about an axis. A core engine section defined about an engine axis and includes a compressor section, a combustor in fluid communication with the compressor section, a turbine section in fluid communication with the combustor including a fan drive turbine, and a geared architecture driven by the fan drive turbine for rotating the fan about the axis. A primary nozzle is defined as a part of the core engine section includes a primary outer diameter at a primary nozzle trailing edge and a primary maximum inner diameter forward of the primary trailing edge. A bypass passage is defined between an inner nacelle surrounding the core engine section and an outer nacelle. The bypass passage includes a secondary nozzle including a secondary outer diameter at a secondary nozzle trailing edge and a secondary maximum inner diameter forward of the secondary trailing edge. A ratio between the maximum inner diameter of the primary nozzle to an outer diameter at the trailing edge of the primary nozzle and a ratio between the maximum inner diameter of the secondary trailing edge and the outer diameter at the trailing edge of the secondary nozzle are both less than about 0.700.

In a further embodiment of the foregoing geared turbofan engine, the ratio between the maximum inner diameter of the primary nozzle and an outer diameter at the trailing edge of the primary nozzle and a ratio between the maximum inner diameter of the secondary trailing edge and the outer diameter at the trailing edge of the secondary nozzle are both within a range between about 0.500 and about 0.700.

In a further embodiment of any of the foregoing geared turbofan engines, the trailing edge of the secondary nozzle comprises a scalloped edge.

In a further embodiment of any of the foregoing geared turbofan engines, the primary nozzle maximum inner diameter defines a portion of a gas path aft of a last turbine stage of the fan drive turbine.

In a further embodiment of any of the foregoing geared turbofan engines, the secondary nozzle maximum inner diameter defines a portion of the bypass passage aft of the fan section.

In a further embodiment of any of the foregoing geared turbofan engines, a ratio between the maximum inner diameter of the primary nozzle to an outer diameter at the trailing edge of the primary nozzle and a ratio between the maximum inner diameter of the secondary trailing edge and the outer diameter at the trailing edge of the secondary nozzle are the same.

In a further embodiment of any of the foregoing geared turbofan engines, a ratio between the maximum inner diameter of the primary nozzle to an outer diameter at the trailing edge of the primary nozzle and a ratio between the maximum inner diameter of the secondary trailing edge and the outer diameter at the trailing edge of the secondary nozzle are different.

A method of assembling a geared turbofan engine according to an exemplary embodiment of this disclosure, among other possible things includes defining a primary exhaust passage about an engine axis including a maximum primary passage inner diameter and a primary passage outer diameter at a primary passage trailing edge, and defining a bypass passage radially outward of the primary exhaust passage including a maximum bypass passage inner diameter and a bypass passage outer diameter at a bypass trailing edge. A ratio of the maximum primary passage inner diameter to the outer diameter of the primary passage and a ratio of the maximum secondary passage inner diameter to the outer diameter of the bypass trailing edge are both less than about 0.700.

In a further embodiment of the foregoing method, the ratio of the maximum primary passage inner diameter to the outer diameter of the primary passage and the ratio of the maximum secondary passage inner diameter to the outer diameter of the bypass trailing edge are both between about 0.500 and about 0.700.

In a further embodiment of any of the foregoing methods, includes configuring the bypass trailing edge as a scalloped shape with the outer diameter defined at an aft most edge of the scalloped shape.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example geared turbofan engine.

FIG. 2 is a schematic view of an example geared turbofan engine including a nacelle structure.

FIG. 3 is a schematic aft view of example primary and secondary nozzles.

FIG. 4 is a side view of an example geared turbofan engine.

FIG. 5 is a prior art view of an example direct drive gas turbine engine.

### DETAILED DESCRIPTION

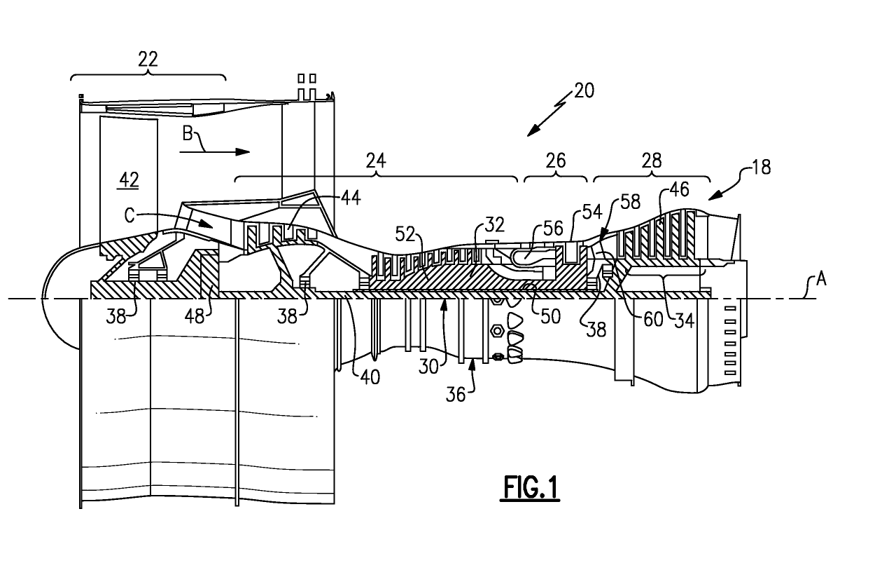

FIG. 1 schematically illustrates an example gas turbine engine 20 that includes a fan section 22, and a core engine 18 including a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis A.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 58 of the engine static structure 36 is arranged generally between the high pressure turbine 54 and the low pressure turbine 46. The mid-turbine frame 58 further supports bearing systems 38 in the turbine section 28 as well as setting airflow entering the low pressure turbine 46.

The airflow through the core flow path C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 58 includes vanes 60, which are in the core flow path C and function as an inlet guide vane for the low pressure turbine 46. Utilizing the vane 60 of the mid-turbine frame 58 as the inlet guide vane for low pressure turbine 46 decreases the length of the low pressure turbine 46 without increasing the axial length of the mid-turbine frame 58. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram ° R)/(518.7° R)]^{0.5}. The “Low corrected fan tip speed”, as disclosed herein according to one non-limiting embodiment, is less than about 1150 ft/second.

The example gas turbine engine includes the fan 42 that comprises in one non-limiting embodiment less than about 26 fan blades. In another non-limiting embodiment, the fan section 22 includes less than about 20 fan blades. Moreover, in one disclosed embodiment the low pressure turbine 46 includes no more than about 6 turbine rotors schematically indicated at 34. In another non-limiting example embodiment the low pressure turbine 46 includes about 3 turbine rotors. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

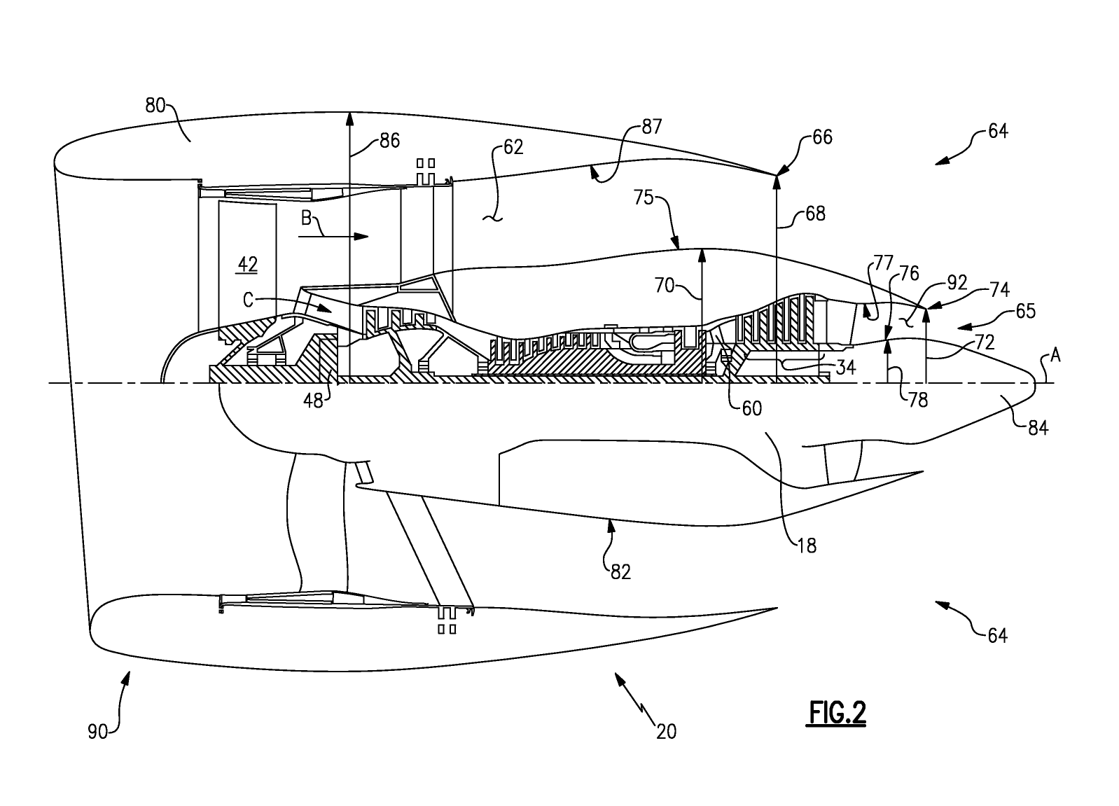

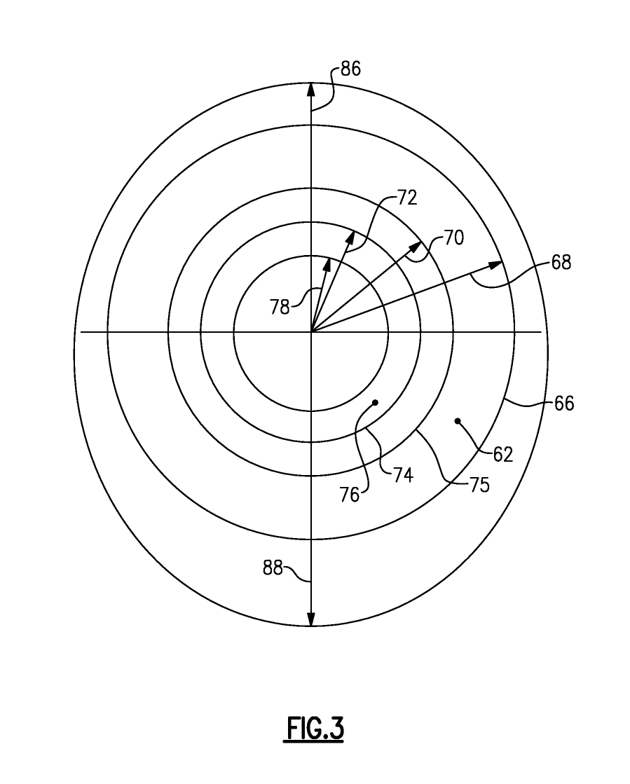

Referring to FIGS. 2 and 3, the example engine 20 includes a nacelle 90 having an outer nacelle 80 and an inner or core nacelle 82. The core nacelle 82 surrounds the core engine 18 and defines a radially inner surface 75 of a bypass passage 62.

The core engine 18 defines an exhaust gas flow path 92 for high speed exhaust gases generated in the combustor section 26 (FIG. 1). An aft end of the core engine 18 includes an aft tail cone 84 about which is defined an annular opening. The annular opening about the aft cone 84 defines a primary nozzle 65. The bypass passage 62 includes an annular opening about the core nacelle 82 that defines a bypass or secondary nozzle 64.

The primary nozzle 65 includes a radially inner surface 76 and a radially outer surface 77. The inner surface 76 includes a maximum inner diameter 78. The secondary nozzle 64 includes the radially inner surface 75 that includes a maximum inner diameter 70.

The primary nozzle 65 is disposed at an aft end of the core engine 18 forward of tail cone 84. The primary nozzle 65 includes a trailing edge 74 with an outer diameter 72 (outer diameter at the trailing edge of the primary nozzle—ODpte) of the core passage 92. An inner surface of the primary nozzle 65 includes the maximum inner diameter 78 (maximum inner diameter of the primary nozzle—IDpmax) disposed forward of the trailing edge 74. In this example, the primary nozzle 65 is disposed aft of the low pressure turbine 46 (FIG. 1).

The secondary nozzle 64 is defined between the outer nacelle 80 and the inner nacelle 82. The inner nacelle 82 defines the interior flowpath surface 75 having a maximum inner diameter 70 (maximum inner diameter of the secondary nozzle—IDsmax) about the engine centerline A. The outer nacelle 80 includes a trailing edge 66 with an outer diameter 68 (outer diameter at the trailing edge of the secondary nozzle—ODste) on an inner surface of the bypass passage 62 and the secondary nozzle 64.

A ratio of the maximum inner diameter 70 of the secondary nozzle 64 to the outer diameter 68 of the secondary nozzle at the trailing edge 66 (IDsmax/ODste) is less than about 0.700.

A ratio of the maximum inner diameter 78 of the primary nozzle 65 to the outer diameter 72 at the trailing edge 74 (IDpmax/ODpte) is also less than about 0.700. Accordingly, the ratio between the maximum inner diameters 70, 78 to the outer diameters 68, 72 at respective trailing edges is less than about 0.700.

In another embodiment a lower bound of the ratios IDsmax/ODste and IDpmax/ODpte is about 0.500 such that a disclosed range of the ratios is between about 0.500 and 0.700. In another embodiment the ratio between a maximum inner diameter and an outer diameter at a trailing edge for the primary and secondary nozzles 65, 64 is less than about 0.695. In a further embodiment the ratio between the maximum inner diameter and an outer diameter at the trailing edge for the primary and secondary nozzles are less than about 0.690. In still a further embodiment the ratio between the maximum inner diameter and the diameter at the trailing edge for both the primary and secondary nozzles are less than about 0.650.

In another disclosed embodiment the ratio between the maximum inner diameter and the diameter at the trailing edge is less than about 0.620. Moreover, it should be understood that ranges of ratios between about 0.500 and 0.700 are within the contemplation of this disclosure.

Moreover, although the specific ratio for each of the primary and secondary nozzles 65 and 64 is within the disclosed ranges, it is not necessary that the each of the primary and secondary nozzles 65 and 64 define identical ratios.

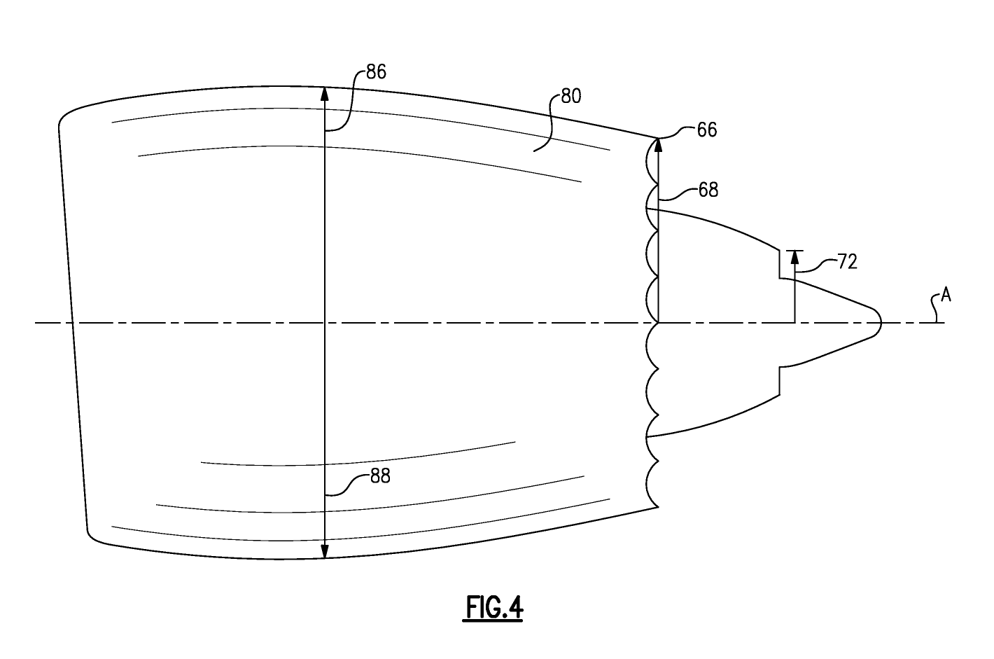

Referring to FIG. 4, with continued reference to FIGS. 2 and 3, the trailing edge 66 of the secondary nozzle 64 may have a scalloped configuration as shown. In this scalloped configuration the diameter 68 is determined at the aft most part of the scallop. The outer nacelle 80 can include a first radius 86 to an upper outer surface and a second radius 88 to a lower outer surface that is different than the first radius to define a substantially oval shaped outer surface of the outer nacelle 80.

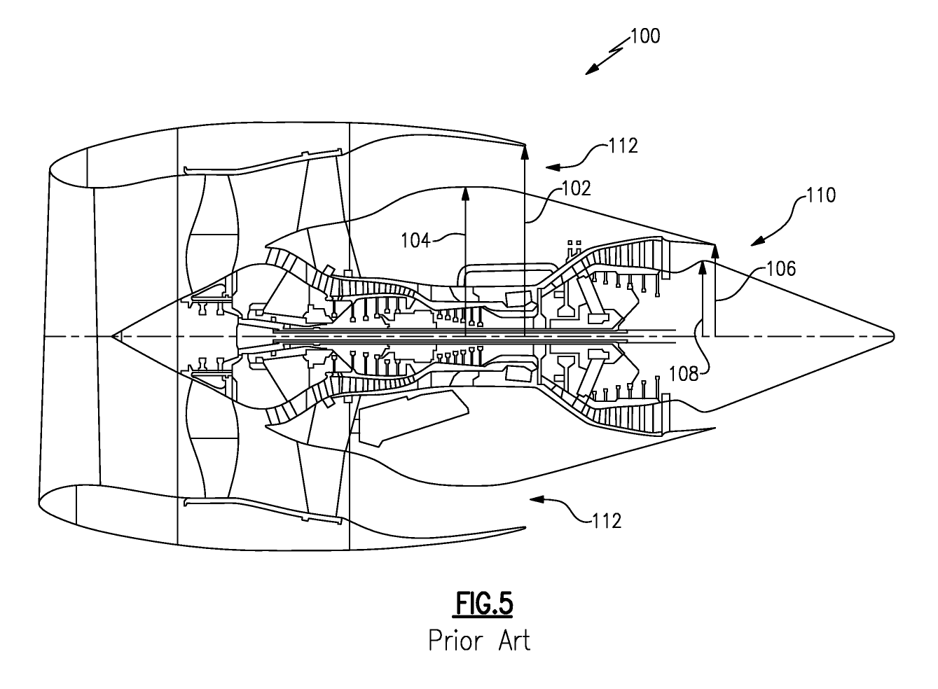

Referring to FIG. 5 with continued reference to FIG. 2, a known direct drive turbofan engine is schematically shown at 100. Direct drive turbofan engines include a fan driven by a direct non-geared connection with one of the turbine sections. A direct drive turbofan includes a primary nozzle 110 and a secondary nozzle 112. The primary nozzle 110 includes an outer diameter 106 at a trailing edge and a max inner diameter 108. The secondary nozzle 112 includes an outer diameter 102 at the trailing edge and max inner diameter 104. Because the example direct drive engine turns the example fan at a speed common with the drive turbine section, the drive turbine section is required to rotate at a slower less efficient speed.

Accordingly, the reduction in speed requires a corresponding increase in size to compensate for the slower speeds. Moreover, the increased drive turbine sizes result in larger nozzle sizes. Therefore, a ratio of the primary nozzle maximum inner diameter 108 relative to the outer diameter 106 at the trailing edge is required to be greater than about 0.700. Furthermore, the larger primary nozzle requires a corresponding increase in size of the secondary nozzle such that a ratio of the secondary nozzle maximum inner diameter 104 to the outer diameter at the trailing edge is also greater than about 0.700.

Referring back to FIGS. 2, 3 and 4, the geared architecture 48 that provides for more optimal speeds fan section 22 enables a smaller fan drive turbine which in this example is the low pressure turbine 46 and thereby the smaller and more efficient primary and secondary nozzles 65, 64. The example geared turbofan configuration enables the ratio of less than about 0.700.

Although an example embodiment has been disclosed, a worker of ordinary skill in this art would recognize that certain modifications would come within the scope of this disclosure.

What is claimed is:

1. A gas turbine engine comprising:
a core engine section defined about an engine axis;
a bypass passage defined about the core engine section; and
a primary nozzle defined as a part of the core engine including a primary outer diameter at a primary nozzle trailing edge and a primary maximum inner diameter forward of the primary trailing edge, wherein a ratio between the inner diameter of the primary nozzle to an outer diameter at the trailing edge of the primary nozzle is less than about 0.700.

2. The gas turbine engine as recited in claim 1, wherein the bypass passage includes a secondary nozzle including a secondary outer diameter at a secondary nozzle trailing edge and a secondary maximum inner diameter forward of the secondary trailing edge, wherein a ratio between the inner diameter of the secondary nozzle to the outer diameter at the trailing edge of the secondary nozzle is less than about 0.700.

3. The gas turbine engine as recited in claim 1, wherein the ratio between the inner diameter of the primary nozzle to the outer diameter at the trailing edge of the primary nozzle is within a range between about 0.500 and about 0.700.

4. The gas turbine engine as recited in claim 2, wherein the ratio between the inner diameter of the secondary nozzle to the outer diameter at the trailing edge of the secondary nozzle is within a range between about 0.500 and about 0.700.

5. The gas turbine engine as recited in claim 1, including a fan section including a plurality of fan blades rotatable about an axis and the core engine section includes a compressor section; a combustor in fluid communication with the compressor section; a turbine section in fluid communication with the combustor; and a geared architecture driven by the turbine section for rotating the fan about the axis.

6. The gas turbine engine as recited in claim 5, wherein the turbine section includes a fan drive turbine driving the fan section through the geared architecture.

7. The gas turbine engine as recited in claim 2, wherein the trailing edge of the secondary nozzle comprises a scalloped edge.

8. The gas turbine engine as recited in claim 1, wherein the primary nozzle maximum inner diameter defines a portion of a gas path aft of a last turbine stage of the core engine section.

9. A geared turbofan engine comprising:
a fan section including a plurality of fan blades rotatable about an axis;
a core engine section defined about an engine axis and including a compressor section; a combustor in fluid communication with the compressor section; a turbine section in fluid communication with the combustor including a fan drive turbine; and a geared architecture driven by the fan drive turbine for rotating the fan about the axis;
a primary nozzle defined as a part of the core engine section including a primary outer diameter at a primary nozzle trailing edge and a primary maximum inner diameter forward of the primary trailing edge; and
a bypass passage defined between an inner nacelle surrounding the core engine section and an outer nacelle, the bypass passage including a secondary nozzle including a secondary outer diameter at a secondary nozzle trailing edge and a secondary maximum inner diameter forward of the secondary trailing edge, wherein a ratio between the maximum inner diameter of the primary nozzle to an outer diameter at the trailing edge of the primary nozzle and a ratio between the maximum inner diameter of the secondary trailing edge and the outer diameter at the trailing edge of the secondary nozzle are both less than about 0.700.

10. The geared turbofan engine as recited in claim 9, wherein the ratio between the maximum inner diameter of the primary nozzle and an outer diameter at the trailing edge of the primary nozzle and a ratio between the maximum inner diameter of the secondary trailing edge and the outer diameter at the trailing edge of the secondary nozzle are both within a range between about 0.500 and about 0.700.

11. The geared turbofan engine as recited in claim 9, wherein the trailing edge of the secondary nozzle comprises a scalloped edge.

12. The geared turbofan engine as recited in claim 9, wherein the primary nozzle maximum inner diameter defines a portion of a gas path aft of a last turbine stage of the fan drive turbine.

13. The geared turbofan engine as recited in claim 9, wherein the secondary nozzle maximum inner diameter defines a portion of the bypass passage aft of the fan section.

14. The geared turbofan engine as recited in claim 9, wherein a ratio between the maximum inner diameter of the primary nozzle to an outer diameter at the trailing edge of the primary nozzle and a ratio between the maximum inner diameter of the secondary trailing edge and the outer diameter at the trailing edge of the secondary nozzle are the same.

15. The geared turbofan engine as recited in claim 9, wherein a ratio between the maximum inner diameter of the primary nozzle to an outer diameter at the trailing edge of the primary nozzle and a ratio between the maximum inner diameter of the secondary trailing edge and the outer diameter at the trailing edge of the secondary nozzle are different.

16. A method of assembling a geared turbofan engine comprising:
defining a primary exhaust passage about an engine axis including a maximum primary passage inner diameter and a primary passage outer diameter at a primary passage trailing edge; and
defining a bypass passage radially outward of the primary exhaust passage including a maximum bypass passage inner diameter and a bypass passage outer diameter at a bypass trailing edge, wherein a ratio of the maximum primary passage inner diameter to the outer diameter of the primary passage and a ratio of the maximum secondary passage inner diameter to the outer diameter of the bypass trailing edge are both less than about 0.700.

17. The method as recited in claim 16, wherein the ratio of the maximum primary passage inner diameter to the outer diameter of the primary passage and the ratio of the maximum secondary passage inner diameter to the outer diameter of the bypass trailing edge are both between about 0.500 and about 0.700.

18. The method as recited in claim 16, including configuring the bypass trailing edge as a scalloped shape with the outer diameter defined at an aft most edge of the scalloped shape.
